(19) United States
(12) Patent Application Publication
(10) Pub. No.: US 2002/0176258 A1
(43) Pub. Date: Nov. 28, 2002

(54) Decorative ribbon

(75) Inventors: Hoi Ching Chau, Kowloon (HK); Chui Ying Cheung, Kowloon (HK)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: New Oriental Industries (H.K.) Limited

(21) Appl. No.: 10/155,591

(22) Filed: May 23, 2002

(30) Foreign Application Priority Data
May 28, 2001 (CN) 01 2 40631.7

(51) Int. Cl. F21S 6/00; F21V 21/00

(52) U.S. Cl. 362/391; 362/123; 362/806; 362/249

(57) ABSTRACT

A decorative ribbon is provided for use in holiday or party events. The ribbon includes a soft string, along which feathers and luminous diodes are arranged. The feathers are densely arranged in the form of strips and are fixed to the soft string. The luminous diodes are arranged among the feathers and are linked by a metal wire that twines around and along the soft string. The termination point of the metal wire is connected with an output interface of an integrated circuit, which is also fixed to the soft string. Waving the decorative ribbon creates a festive atmosphere, especially at night.

### FIELD OF THE INVENTION

The present invention relates to a decorative ribbon suitable for use in holiday events, birthday parties, etc.

### BACKGROUND OF THE INVENTION

In holiday events or birthday parties, people may use decorative ribbons to heighten a festive atmosphere. In particular, children like to wave these decorative ribbons. Traditional decorative ribbons have been commonly made with colorful slips of cloth, or by splitting wide and colorful slips of cloth into narrow ones and sewing them together at their ends, which are only usable in daylight. Oftentimes, however, people wish to have celebrations or parties at night. The traditional decorative ribbons are imperfect to meet such needs.

### SUMMARY OF THE INVENTION

The object of the present invention is to provide a decorative ribbon that can be used at night.

To achieve the object described above, a decorative ribbon of the present invention includes a soft string, feathers, luminous diodes, and an integrated circuit to control the luminous diodes. The feathers are densely arranged in the form of strips, which are fixed to and along the soft string. The luminous diodes are arranged among the feathers and linked by a metal wire that is twined around and along the soft string. The termination point of the metal wire is connected with the output interface of the integrated circuit. The circuit board of the integrated circuit is also fixed to the soft string.

In one embodiment, the feathers of the present invention may be processed turkey feathers.

The decorative feather ribbon with electronically controlled colorful luminous diodes, formed in accordance with the present invention, can be used in a traditional manner to heighten the atmosphere of various celebrations and parties, and furthermore can be used at night. When the decorative ribbon of the present invention is waved, it helps create an atmosphere that is colorful, shining, glorious, splendid, and cheerful, especially at night.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a schematic structure diagram of the present invention in accordance with one embodiment; and

FIG. 2 is a circuit diagram of the integrated circuit for use in the embodiment shown in FIG. 1.

### DETAILED DESCRIPTION OF THE PREFERRED EMBODIMENT

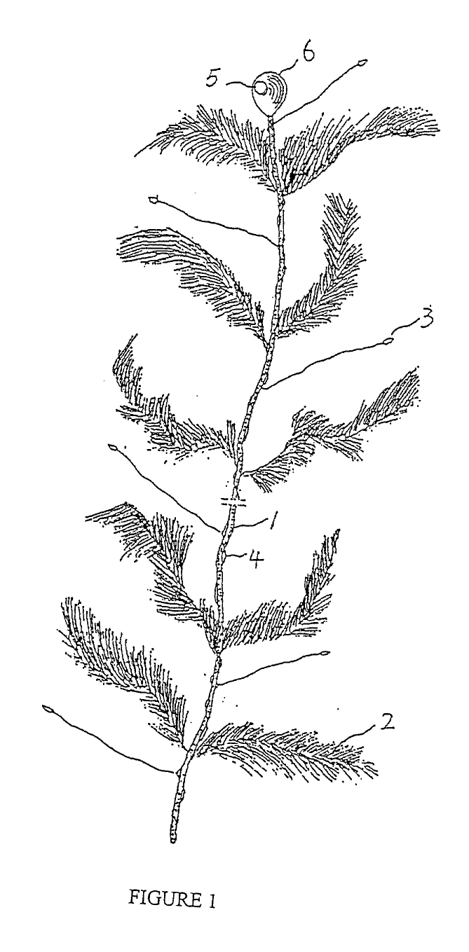

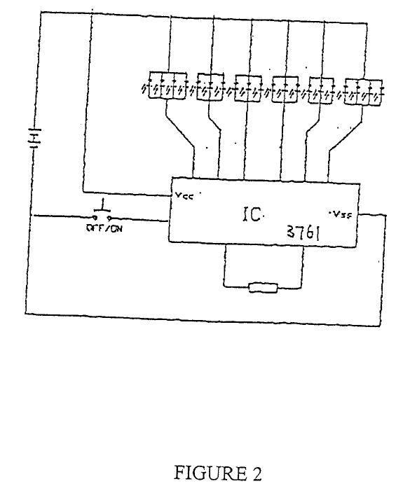

As shown in FIG. 1 and FIG. 2, an embodiment of a decorative ribbon according to the present invention includes: a string 1 made of, for example, cotton yam; feathers 2, such as turkey feathers; luminous diodes 3; and an integrated circuit (IC) (sealed in a box 6, as more fully described below) provided to control the luminous diodes 3. The feathers 2 are typically processed through high-temperature sterilization (disinfection), de-greasing, dyeing, bleaching, etc. and also undergo processing to retard flammability. Thereafter, the feathers 2 are densely arranged in the form of strips by hands and sewed to the string 1. The luminous diodes 3 are arranged among the feathers 2 and are linked by a metal wire 4. The number of the luminous diodes 3 may be increased or decreased according to the length of the soft string 1. The metal wire 4 twines around the soft string 1, and its termination point is connected with the output interface of the integrated circuit. In the illustrated embodiment, the chip model of the integrated circuit is 3761 (see FIG. 2), which can be programmed to control the period and order of flashing of the luminous diodes 3. The chip model is selected based on the number of the luminous diodes 3. Also, in the present embodiment, the power supply for the integrated circuit is provided by two 1.5V button batteries and is controlled a micro-mechanical button switch 5. The circuit board of the integrated circuit is sealed inside an insulating box 6 and is fixed at the end of the soft string 1, and thus the button switch 5 can be pressed easily. As will be apparent to those skilled in the art, the mechanical button switch may be replaced with a semi-automatic switch, such as a mercury switch, so that the luminous diodes 3 can flash automatically only by waving the decorative ribbon, without pressing any button switch.

While the preferred embodiments of the invention have been illustrated and described, it will be appreciated that various changes can be made therein without departing from the spirit and scope of the invention.

The embodiments of the invention in which an exclusive property or privilege is claimed are defined as follows:

1. A decorative ribbon, comprising:
a string;
feathers arranged in the form of strips and fixed to the string;
luminous diodes arranged among the feathers;
an integrated circuit for controlling the luminous diodes, the integrated circuit being fixed to the string; and
a wire used to link the luminous diodes, the wire twining around the string, and the termination point of the wire being connected with an output interface of the integrated circuit.

2. The decorative ribbon according to claim 1, wherein the feathers comprise turkey feathers.

3. The decorative ribbon according to claim 1, wherein the string comprises a cotton yarn.

4. The decorative ribbon according to claim 1, wherein the integrated circuit comprises a chip model 3761.
